(19) United States
(12) Patent Application Publication
(10) Pub. No.: US 2014/0305381 A1
(43) Pub. Date: Oct. 16, 2014

(54) GRADUATED ORDER STEP PET PUZZLE TOY

(71) Applicant: Kyle Hansen, Castle Rock, CO (US)

(72) Inventor: Kyle Hansen, Castle Rock, CO (US)

(21) Appl. No.: 13/861,335

(22) Filed: Apr. 11, 2013

(51) Int. Cl. A01K 15/02

(52) U.S. Cl. CPC A01K 15/025
USPC 119/711

(57) ABSTRACT

The invention relates to a novel pet toy wherein the pet must determine how to solve the puzzle and obtain treats located in concealed receptacles in the base portion of the toy. Treats are located in receptacles wherein retrieval may be prevented or allowed when the animal is required to remove tab affixed “step blocks” in a specific order to retrieve the treats. Step blocks cannot be removed out of order or complete removal is prevented.

### FIELD

The invention relates to a novel pet toy in which treats are located in receptacles wherein retrieval may be prevented or allowed when the animal is required to remove step blocks in a specific order to reveal the treat receptacles.

### BACKGROUND OF THE INVENTION

The invention most closely corresponds with USPTO Class 119/702 wherein Class 119 relates to animal husbandry and sub-class 702 includes exercise or amusement devices for animals.

In its simplest form, the invention comprises a novel puzzle wherein treats are inserted into receptacles and a pet must learn to remove all of the step blocks which are linked together and affixed to the toy base in order so that the pet may retrieve treats from the base receptacles.

It is well known in the animal behavior sciences that is a dog doesn't get the mental stimulation it needs it will develop Behavior problems such as chewing, biting or elimination in the home due to boredom, stress or depression. Veterinary science has also determined that in addition to behavioral problems, a dog will also be more prone to diseases as the immune system can weaken due to stress or depression. Thus it is key to challenge a dog with activities such as the inventive puzzle.

### THE INVENTION

### Summary, Objects and Advantages

All who studied any form of psychology in school remember Pavlov's Dogs. A simple conditioning test resulted in dogs remembering or being cognitive of being given a treat when a bell was rung. Thus the dogs would respond in various cognitive ways when a bell was rung. This behavior presented itself for months after the actual tests were ceased. Pavlov evidenced that dogs actually had memory and the ability to react to certain stimuli on a consistent basis.

In the inventive toy, there are three numbered step blocks which are tabbed in such a way as to be affixed to one another as well as to the base. Within the base are individual depressions which serve as receptacles for pet treats as well as the step blocks, which vary slightly in size.

The numeric portions exist in that manner more as a guide for the human to replace the steps or blocks, but also are cutouts so as to serve as scent holes to entice the pet into solving the puzzle. Since a pet must exert a reasonable amount of force to remove the tabbed step blocks, there are attachment holes located on the toy base for optional fixation to a surface to keep the toy immobile.

A pet owner may insert treats in any number of the three treat receptacles. The steps or blocks must be removed in numeric order, e.g. block 1 must be removed first. If a pet attempts to first remove block 2 it cannot as blocks 1 and 3 will remain affixed. This requires keen cognitive and reasoning skills on the dog's part as it will have to truly “learn” to remove the blocks in the correct order.

Further, if a pet owner places a treat in receptacle 2 only, the dog must also become cognizant of the fact that it has to still solve the puzzle to get to the treat which it will detect via the scent holes in the blocks. Such reasoning and learning requirements will keep a pet engaged with this particular puzzle toy for quite some time making the toy a sound purchase for pet owners.

### BRIEF DESCRIPTION OF THE DRAWINGS

The invention is described in further detail by reference to five drawings sufficient in detail to describe the invention in which:

FIG. 1 is a perspective view of the toy showing all step blocks in situ;

FIG. 2 is an illustrative view of the method in which a pet may remove a step block;

FIG. 3 illustrates the toy with two step blocks removed to expose treat receptacles;

FIG. 4 is a side view showing the graduated step blocks clarifying size, shape and indentation; and

FIG. 5 is a bottom view showing the connection tabbing and basic receptacle shapes.

### DETAILED DESCRIPTION, INCLUDING BEST MODES OF CARRYING OUT THE INVENTION

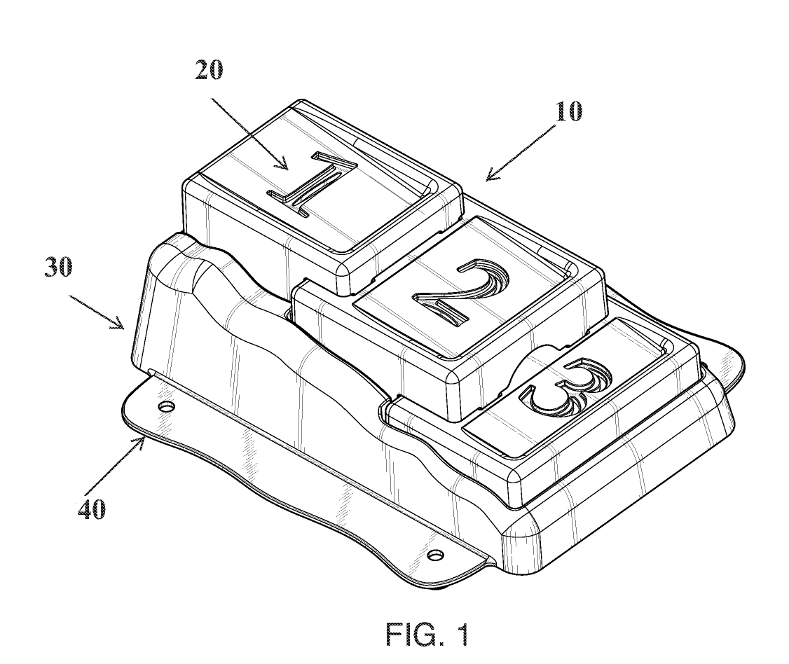

FIG. 1 illustrates the toy with all blocks in situ 10. The scent holes 20 are shown as the cutout numbers which again are more for the humans visually to know in which order and place to put the step blocks back in the toy after a pet has solved the puzzle. The base 30 is also illustrated. Located on the base are apertures 40 wherein a pet owner may affix the toy to a surface so as to keep it immobile during pet play. Since a reasonable amount of force is required to remove the step blocks, this is an advisable method of use.

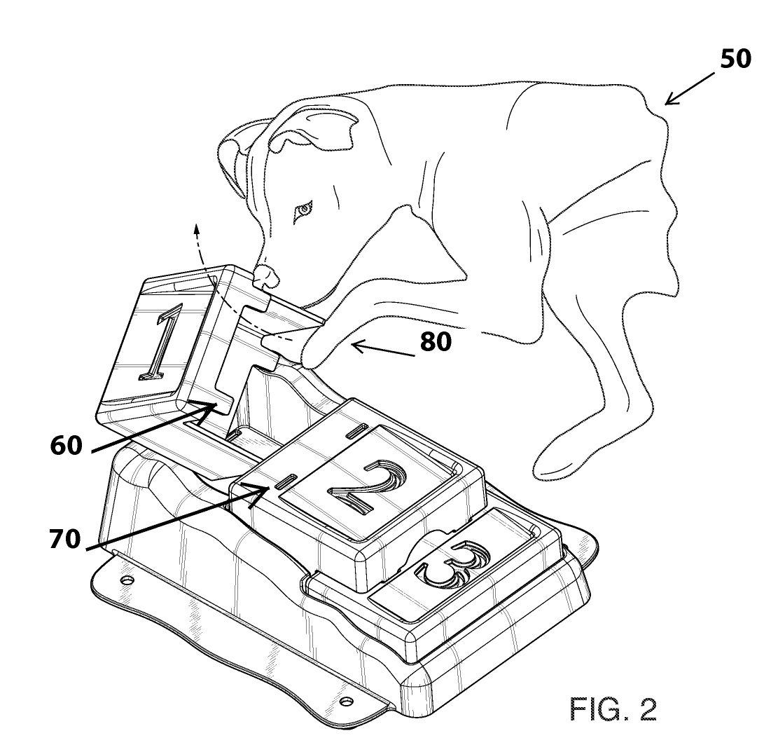

FIG. 2 obviously shows a dog 50 solving the puzzle toy. The tabs 60 affix the step blocks to one another so that they must be removed in “numerical order” to completely solve the puzzle. Tab insertion points 70 hold the step blocks in place. The dog must ideally use a combination of its snout and paw 80 to remove a step block.

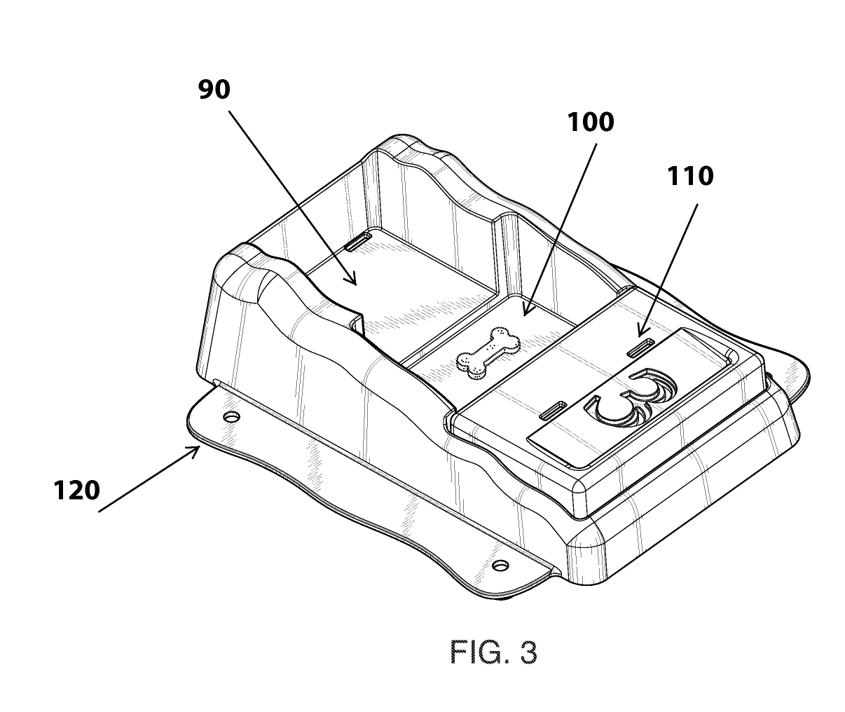

FIG. 3 reveals the treat receptacles 90 after the pet has removed step blocks 1 and 2. In this illustration a treat 100 has only been placed in receptacle 2 which requires more cognitive and reasoning skill from the pet. It will smell the treat but not attain it until it removes the second step block. The step block tab insertion point 110 is shown where block 2 was removed. Anchor apertures 120 are shown so that the pet owner may affix to a surface so that the toy does not slide while the pet places pressure on it, for which a reasonable amount of force will be required to remove the step blocks.

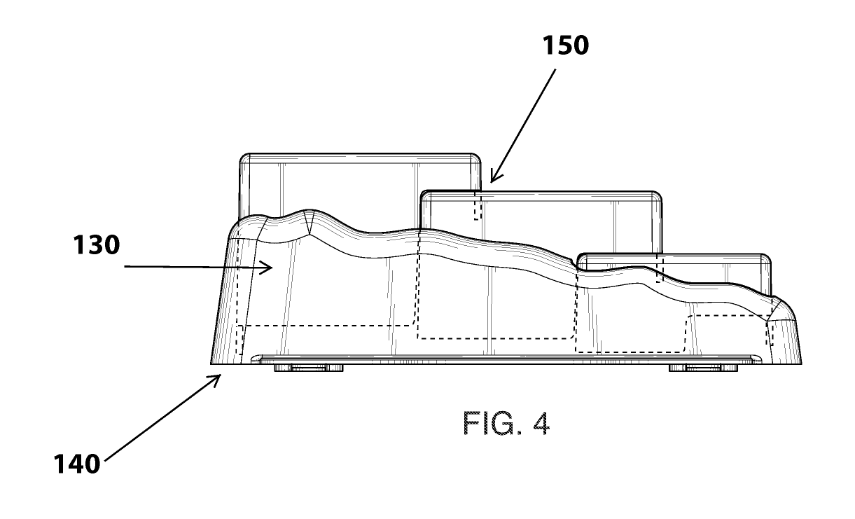

FIG. 4 is a side view of the puzzle toy. The step blocks 130 are shown partially in phantom to illustrate how they rest in the base 140, and that they vary in size. Also in phantom are the connection tabs 150 which hold the step blocks together. It can be seen by this figure that the depth of the step blocks create a challenge for removal by a pet and cannot be jarred out of place easily.

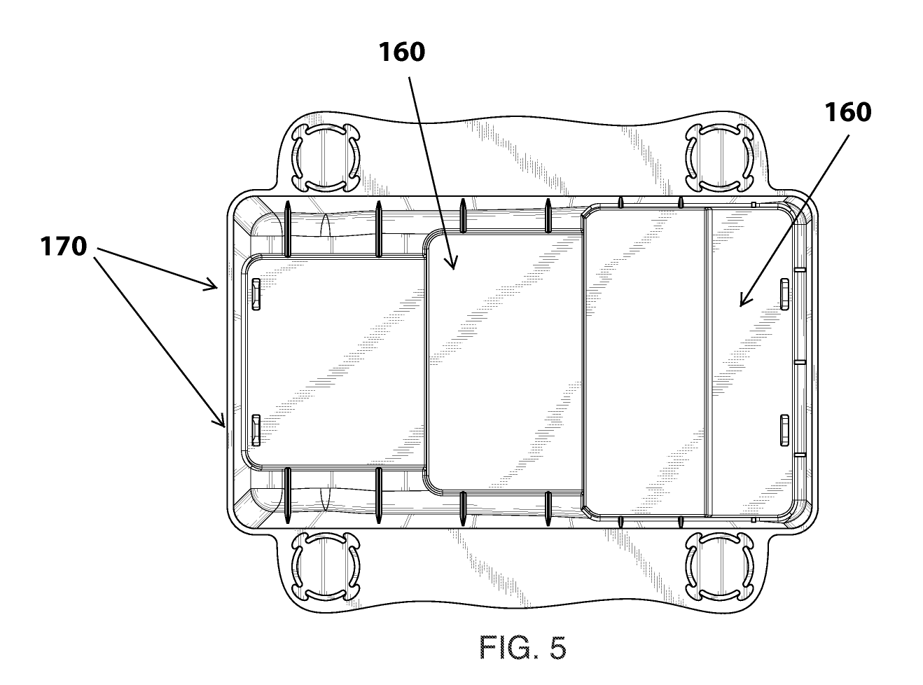

FIG. 5 is a bottom view of the puzzle toy. The treat receptacles 160 are illustrated as they recede into the molded base. The connecting tabs 170 which also anchor the step blocks to the base are also shown in this view.

1) A graduated step pet puzzle toy with treat receptacles comprising;
a) a base piece with indentations
b) tabbed step blocks
c) scent holes
d) anchoring apertures

2) A pet puzzle toy as in claim 1 wherein the base piece is a molded plastic base with indentations capable of receiving tabbed step blocks and pet treats.

3) A pet puzzle toy as in claim 1 wherein tabbed step blocks are squared and link to one another as well as the base with protruding tabs and receiving holes.

4) A pet puzzle toy as in claim 1 wherein the step blocks contain numeric-shaped cutouts to allow sensory detection of inserted pet treats.

5) A pet puzzle toy as in claim 1 wherein the base piece has anchoring apertures wherein a user may affix the entire toy to a surface to prevent movement.
